(19) United States
(12) Patent Application Publication
(10) Pub. No.: US 2017/0169448 A1
(43) Pub. Date: Jun. 15, 2017

(54) Applying Priority Matrix to Survey Results

(71) Applicant: Survature, Inc., Knoxville, TN (US)

(72) Inventors: Jian HUANG, Knoxville, TN (US); Steven CHIN, Raleigh, NC (US)

(73) Assignee: Survature, Inc.

(21) Appl. No.: 15/276,608

(22) Filed: Sep. 26, 2016

Related U.S. Application Data
(60) Provisional application No. 62/232,140, filed on Sep. 24, 2015.

(51) Int. Cl. G06Q 30/02; G06F 17/30

(52) U.S. Cl. CPC G06Q 30/0203; G06F 17/30964

(57) ABSTRACT

A method for preparing survey data for display is disclosed comprising retrieving, from a database, respective responses to at least one survey question in a survey taken by a plurality of respondents and behavior data recorded during taking of the survey by the plurality of respondents, in response to a query comprising the at least one survey question. The retrieved behavioral data is analyzed to derive individual non-explicit information for the respective respondents and non-explicit group information is derived from the individual non-explicit information. The retrieved responses are aggregated to derive aggregated explicit information. The derived explicit and non-explicit group information are configured to be displayed in the form of a two-dimensional grid. The configured listing is sent to a user's computing device, via a network for display, and the configured listings are displayed on a user's display device as two-dimensional grid, by the user's browser.

### RELATED APPLICATIONS

The present application claims the benefit of U.S. Patent Application No. 62/232,140, which was filed on Sep. 24, 2015, is assigned to the assignee of the present invention, and is incorporated by reference herein in its entirety. The present application is related to U.S. patent application Ser. No. 14/172,658, which was filed on Feb. 4, 2014, published on Aug. 17, 2014 bearing U.S. Patent Publication No. 2014/0222514, (the '514 Publication) is assigned to the assignee of the present application, and is incorporated by reference herein in its entirety.

### BACKGROUND OF THE INVENTION

Many companies use a common tool known as an Importance-Satisfaction matrix in evaluating how to maximize the benefits of respective improvements by specifically targeting areas for highest impact. This matrix is generally visualized as a two-by-two matrix with satisfaction as the first variable and importance as the second variable. In general, the terms the terms “Priority” and “Importance” are interchangeable. An example of such a matrix is shown in FIG. 1. (See, for example, Di Paula, Adam and Justason, Barb “Understanding what customers want and diagnosing how to improve,” Quirks, Marketing Research Media (2003), available at http://www.quirks.com/articles/a2003/20031004.aspx?searchID=149476032).

For purposes of illustration, consider a typical hotel satisfaction survey asking its customers about their experiences during their recent stay. The survey asks questions about how satisfied were the customers with the quality and value of the hotel's services and amenities and how important were each service and amenity. The rating scale for satisfaction and importance can be from 1 to 5 or 1 to 10 so long as there is some numerical value assigned to the rating. In a two-by-two matrix, the analysis can be placed in a simple four-quadrant graph to show stated importance/satisfaction, as shown in the FIG. 1, where “On-Time Performance” and “Safety” were found to be of High Stated Importance and Higher Satisfaction to customers of the hotel. These services are therefore considered to be Key Strengths of the hotel. “Cleanliness” was found to be of Higher Satisfaction but Low Stated Importance, and is therefore considered to be an Asset of the hotel. Crowding was found to be of Low Satisfaction but also Low Stated Importance, so it is considered to be a Vulnerability but not a Threat to the hotel.

In the industry, importance may be measured in two ways: 1) stated and 2) derived. In simple terms, stated importance means that respondents are asked explicitly to state the level of importance of an object, such as an item or service, for example, by assigning a rating or a rank. Measuring derived importance is accomplished through many different techniques, including multivariate analysis, correlation, and regression analysis. The typical methods for measuring derived importance are the use of bivariate correlation, standard regression coefficient (or beta weight), and the product of the beta weight and the corresponding correlation. In essence, each object or predictor variable is related to a broader measure or criterion variable, such as satisfaction, to identify the object's impact on the broader measure.

Both stated importance and derived importance have benefits and limitations, including measurement and social bias. (See, for example, Chrzan, Keith and Kavecansky, Juraj, “Stated ‘Versus’ Derived Importance: A False Dichotomy,” Maritz White Papers (2010), available at: http://wvvw.maritz.com/˜/media/Files/MaritzDotCom/White%20Papers/Research/Stated-vs-Derived-Importance.ashx.).

### SUMMARY OF THE INVENTION

The present application incorporates by reference U.S. patent application Ser. No. 14/172,658, which was filed on Feb. 4, 2014, was published on Aug. 7, 2014 bearing U.S. Patent Publication No. 2014/0222514, and is assigned to the Assignee of the present application (“the '514 Publication”). The methods and systems described in the '514 Publication 1) provide a graphical user interface (“GUI”) to present survey questions and capture explicit and non-explicit responses to the survey questions, and 2) analyze the respondents' behavior while responding to the survey. In one example, the survey provides boxes for different respective options on a rating scale and items or services, referred to as objects, for placement by the respondent in an appropriate rating box. Objects may be displayed in the survey in the form of words, phrases, and/or images, for example. Examples of the respondents' behavior during the placement of objects in ratings boxes, for example, include the order of placement of respective objects; the timing of such placement, including changes in the speed of placement of respective objects; changes in the placement of respective objects, etc. Such non-explicit information may be used to derive a measure of importance or priority.

Explicit ratings over all or a group of respondents may be determined by averaging the ratings from each of the respondents. The average may be a mean or median, for example. Non-explicit information may similarly be derived from a survey in which objects are listed, next to ratings and the respondent selects the appropriate rating for each object. Similarly, non-explicit information, such as timing of answering, changes answers, order of answering, etc., may be monitored to derive a measure of importance or priority. Measures of importance or priority may be better described as a measurement of “group salience.”

Non-explicit information may provide valuable insights into the degree of confidence, importance, and relevance the respondent attaches to each response, and may result in a modification of the explicit information. For example, if a respondent takes longer to place a respective object than the time taken to place other objects, it may be indicative of indecision or a low priority of a particular object, for example. Similarly, if a respondent changes a response, the respondent may feel less strongly about the placement of a particular object. The number and types of changes made by the respondent may also provide additional insight into the respondent and the value to be afforded that respondent's responses. For example, dramatic swings in answers may provide insight into whether the respondent was careless about the response or whether the respondent was faking the response. Behavior such as this could cause a stated rating to be discounted. Similarly, the first object placed and/or the fastest object placed may indicative of high importance to the respondent, positively or negatively, causing the resulting rating to be given higher value.

Both explicit and non-explicit information may be derived from the same response. For example, if a respondent changes their rating response, the final selection is considered to be explicit information while the fact that a change was made is considered to be non-explicit information. If the survey analyst were to compare the results of surveys across groups of respondents, the patterns and rankings of explicit and non-explicit responses may provide further insights into group behavior and demographics.

In accordance with an embodiment of the invention, methods and systems are disclosed for displaying survey results in a two dimensional graph or chart, where one dimension is priority or importance, as derived from analyzing explicit and non-explicit responses as described in the '514 Publication, and the other dimension is a rating, as derived from explicit responses. The explicit ratings may also be impacted by non-explicit information. For example, if there is an indication from the behavior related to the answer that an answer is faked, the result of indecision (too slow), or lack of consideration (too fast), those answers may not be considered in determining the averaged rating, for example.

In accordance with a first embodiment of the invention, a method for preparing survey data for display is disclosed comprising retrieving, from a database, respective responses to at least one survey question in a survey taken by a plurality of respondents and behavioral data recorded during taking of the survey by the plurality of respondents, in response to a query comprising the at least one survey question. The retrieved responses are aggregated to derive aggregated explicit information. The retrieved behavioral data is analyzed to derive individual non-explicit information for the respective respondents. Non-explicit group information is derived from the individual non-explicit information. The derived explicit information and the derived non-explicit group information are configured to be displayed in the form of a two-dimensional grid. The configured information is sent to a user's browser, via a network; and displayed on a user's display device in the form of the two-dimensional grid, by the user's browser, for example.

The retrieved data may comprise respective pairings of objects and ratings related to a respective survey question, where objects comprise words, phrases, and/or images. The ratings may be selected from a Likert scale in the survey, for example. The ratings comprise explicit information, which may be aggregated to generate statistical summary. The statistical summary may comprise an average, such as a median or a mean, for example.

Each pairing is stored in a respective record in the database, and at least certain of the records further comprise behavioral measures of the behavior of a respective respondent with respect to pairing a respective object with a rating. The non-explicit group information comprises derived priority, and deriving the non-explicit group information comprises performing a statistical analysis of the behavioral measures in the records of respective respondents to derive the derived priority of a respective object.

The statistical analysis may comprise one or more of the following: object-order of choice relationship analysis, object-topic relationship analysis, object, object-rating scale, relationship analysis, and object-latency relationship analysis. A respective retrieved response may be deleted from the aggregated retrieved responses based on the derived non-explicit information. The resulting statistical summary of the explicit ratings may thereby be changed.

A list of pairings of a derived priority and a statistical summary of the explicit ratings may be formed, for a respective object. The listing may be configured to be displayed in the form of the two-dimensional grid. The configured listing may be provided to a computing device, via a network, and displayed on the user's display device in the form of the two-dimensional grid, by the user's browser.

The list of pairings further comprises at least one measure of a non-explicit characteristic for a plurality of respondents. The characteristic may comprise one or more of the following types of non-explicit information: a number of respondents responding to a question; a number of respondents who spent less than a first predetermined amount of time before responding to a question; a number of respondents who spent more than a second predetermined amount of time before responding to a question; and/or a number of responders who changed their response, for example. Whether the first and/or second predetermined amounts of time are exceeded may be determined based, at least in part, on time stamps associated with respective pairings.

The query may be limited to one or more subgroups of respondents. A separate listing for each subgroup, and/or a separate listing for each subgroup of a subgroup may be formed. Each listing may be configured to be displayed on the same two-dimensional grid, or separate grids. The listing may be configured to cause display of one or more icons representative of the statistical summary of the explicit ratings and derived priorities for respective objects, on the two dimensional grid. The listings may be further configured to enable one or more of the following: varying the size of a respective icon based on a number of respondents that have selected the respective object in the survey; varying a color and/or opacity of a respective icon based on a number of respondents that have changed their selection on a rating scale; connecting corresponding icons for respective subgroups; causing display of additional information in response to placement of a mouse over an icon; causing highlighting of the icon in response to placement of a mouse over an icon causes highlighting of the icon; and causing display of information in the form of a tabular chart, bar chart, and/or pie chart. The data may be visualized and displayed in other manners, as well. The listings may be configured by adding Javascript visualization code and/or HTML code to each listing. The two-dimensional grid may comprise a matrix comprising at least two regions.

In accordance with another embodiment of the invention, a system for preparing survey data for display is disclosed comprising a database; and a processor. The processor is configured to retrieve, from the database, respective responses to at least one survey question in a survey taken by a plurality of respondents and behavioral data recorded during taking of the survey by the plurality of respondents, in response to a query comprising the at least one survey question. The processor is further configured to analyze the retrieved behavioral data to derive individual non-explicit information for the respective respondents and aggregate the retrieved responses to derive aggregated explicit information. The processor is further configured to derive non-explicit group information from the individual non-explicit information, and configure the derived explicit information and the derived non-explicit group information to be displayed in the form of a two-dimensional grid. The configured information is sent to a user's browser, via a network, for display the configured information on a user's display device in the form of the two-dimensional grid, by the user's browser, for example. Any or all of the features described above with respect to the first disclosed embodiment are also applicable to this embodiment.

In accordance with another embodiment of the invention, a system for displaying survey data comprises a display device and a processor coupled to the display device. The processor is configured to send a query prepared by a user to a web server via a network. The query comprises a survey question and one or more subgroups of respondents. The survey question is from a survey that collected explicit information and non-explicit information based on a behavior of the respondents while answering the survey question. The processor is further configured to receive explicit and non-explicit information responsive to the query from the web server, where the explicit and non-explicit information is configured to be displayed in the form of a two-dimensional grid. The processor is configured to cause display of the received explicit and non-explicit information on the display in the form of the two-dimensional grid. The processor may be further configured to combine the explicit and non-explicit information with the query, and cause display of the explicit and non-explicit information with the query on the two-dimensional grid. Any or all of the features described above with respect to the first disclosed embodiment are also applicable to this embodiment.

In accordance with another embodiment of the invention, a method of displaying survey data is disclosed comprises preparing a query comprising a survey question and one or more subgroups of respondents. The survey question is from a survey that collected explicit information and non-explicit information based on a behavior of the respondents while answering the survey question. The query is sent to a web server via a network. Explicit and non-explicit information responsive to the query are received from the web server, where the explicit and non-explicit information as configured to be displayed in the form of a two-dimensional grid. The received explicit and non-explicit information is then displayed on the display in the form of the two-dimensional grid. The method may further comprise combining the explicit and non-explicit information with the query, and causing display of the explicit and non-explicit information with the query on the two-dimensional grid. Any or all of the features described above with respect to the first disclosed embodiment are also applicable to this embodiment.

### BRIEF DESCRIPTION OF THE DRAWINGS

FIG. 1 is an example of a satisfaction vs. importance, two-by-two matrix, divided into quadrants;

FIG. 2 is an example of another two-by-two matrix, divided into quadrants, of derived importance versus rating, in accordance with an embodiment of the invention;

FIG. 3 is an example of a matrix comparing explicit responses, as in FIG. 1, to the use of non-explicit information along with explicit information, in accordance with an embodiment of the invention;

FIG. 4 is a block diagram of an example of a system for implementing embodiments of the invention;

FIG. 5 are examples of a GUI that may be displayed by a web browser on the display of the computing device of a survey taker to enable the survey taker to take a survey that collects explicit and non-explicit information, for use in accordance with an embodiment of the invention;

FIG. 6 is an example of the GUI of FIG. 5, after being at least partially completed by a survey taker;

FIG. 7 is an example of a presentation of the priority and rating information of a hotel customer satisfaction survey in the form of a matrix, in accordance with an embodiment of the invention

FIG. 8 is an example of a presentation of the priority and rating information with segmentation comparisons between business travelers and leisure travelers, in accordance with an embodiment of the invention

FIG. 9 is an example of the display of actual survey results along with additional information for a respective object, in accordance with another embodiment of the invention;

FIG. 10 is another example of the display of the actual survey results of the survey of FIG. 9, for different segments, along with additional information for another respective object, in accordance with another embodiment of the invention;

FIG. 11 is another example of the display of the actual survey results of the survey of FIG. 9, with different additional information for another respective object, in accordance with another embodiment of the invention;

FIG. 12, the list view is a tabular view of display of information, in accordance with an embodiment of the invention;

FIGS. 13A-13C are examples of additional ways to display information, in accordance with another embodiment of the invention;

FIG. 14A is a block diagram of an example of a system, for survey analysts to acquire survey data for display, in accordance with an embodiment of the invention;

FIG. 14B is flowchart of an example of a method of processing survey data for display as a two-dimensional grid, by the system of FIG. 14A, in accordance with an embodiment of the invention; and

FIG. 15 is an example of a flow diagram of the process of FIG. 14B and the system FIG. 14A.

### DETAILED DESCRIPTION

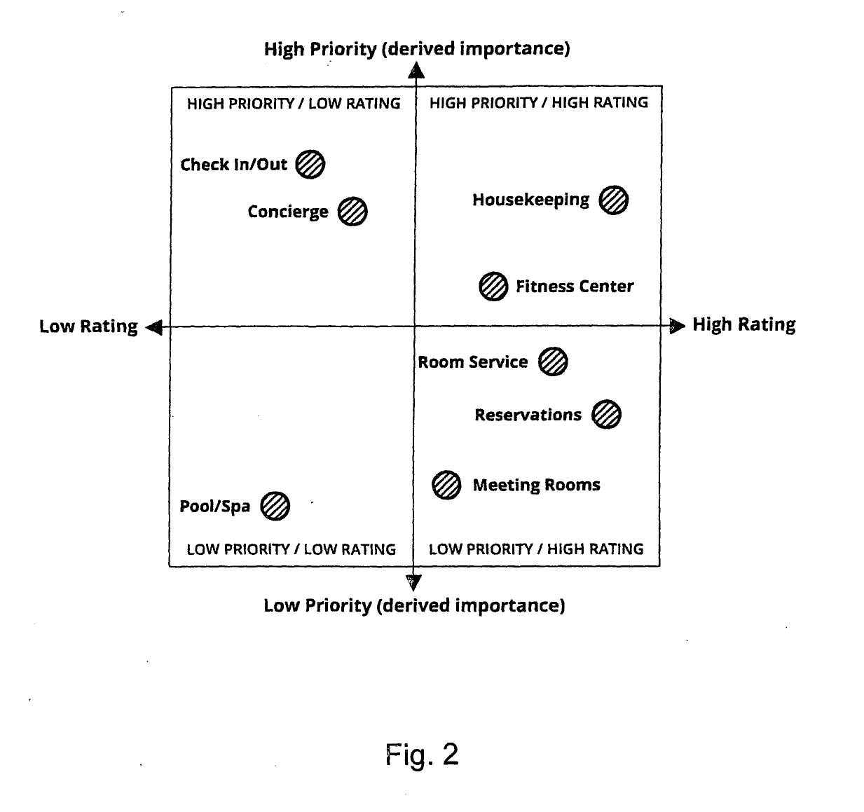

FIG. 2 is an example of a two-by-two matrix including four quadrants, where the x-axis is rating, from Low Rating to High Rating of satisfaction, and the y-axis is derived importance (priority) from Low Importance (derived importance) to High Importance (derived importance), based at least on non-explicit information and possibly explicit information, in accordance with an embodiment of the invention. The x-axis and y-axis are interchangeable and may be varied in accordance with the desires of the survey analyst (also referred to as a “user”). The survey questions resulting in the matrix included a list of services related to a hotel, such as Housekeeping, Fitness Center, Check In/Out, Concierge, Room Service, Reservations, Meeting Rooms, and Meeting Rooms, and ratings, such as Poor, Satisfactory, and Excellent, for example. The guest is asked to rate the respective services on a GUI displayed on their computing device, such as the GUI described in the '514 Publication, for example. The derived importance and ratings for each service are displayed in accordance with an embodiment of the invention in FIG. 2.

In the first quadrant, services are rated high in satisfaction and high in priority. This quadrant is considered an area of strength, and a reason that customers keep coming back. Housekeeping and Fitness Center fell into this quadrant. Based on these results, a hotel client may be advised to keep doing what it is doing in these areas because its customers are very satisfied with them and find them important.

In the second quadrant, services were rated high in satisfaction and low in priority. Improvement in this area may not significantly affect the customer's satisfaction level. Meeting Rooms fell into this quadrant because in this example, this hotel's typical customers are business travelers who are not coming for conferences or meeting at the hotel. With most of these, customers leaving the hotel during the day and only returning in the evening, meeting rooms are not considered a priority. The hotel may, therefore, consider reducing spending on meeting rooms.

In the third quadrant, services are rated low in satisfaction and low in priority. This quadrant is considered an area of low priority because improvement in this area will not significantly affect a customer's decision to stay at this hotel. The pool service fell into this quadrant. Because the hotel in this example is located closer to businesses and away from family attractions, it does not appeal to a lot of families with small children who would actually use the pool. Most of the customers would not appreciate any improvements in the pool.

In the fourth quadrant, services are rated low in satisfaction and high in importance. The Check In/Out service and Concierge services fell into the fourth quadrant. This quadrant is considered an area of concern. Because the customers have identified these services as high in importance, if improvements in these areas are not made, customers may be lost.

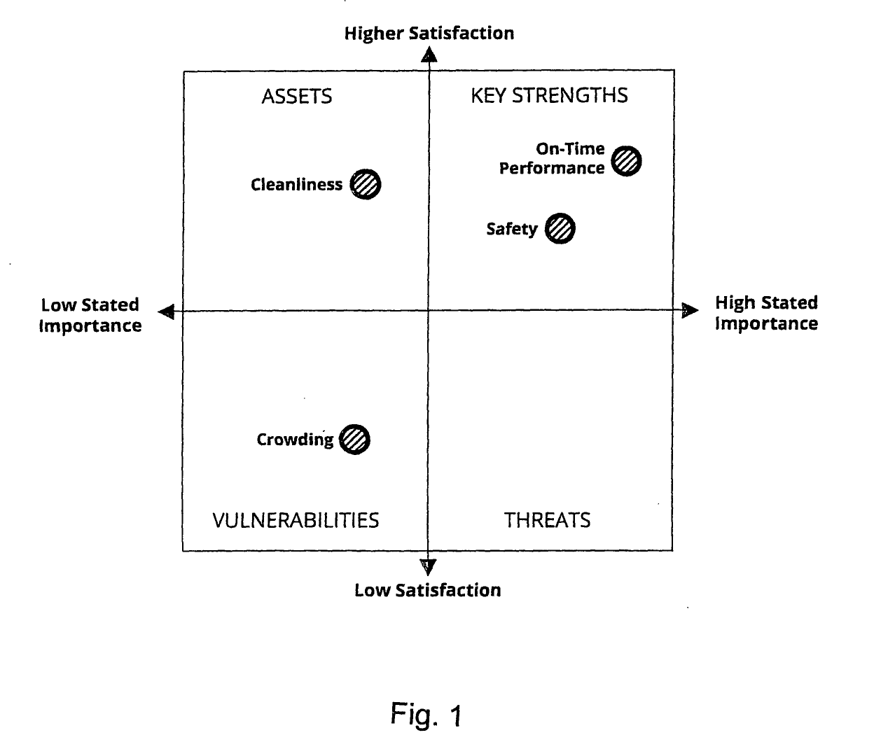

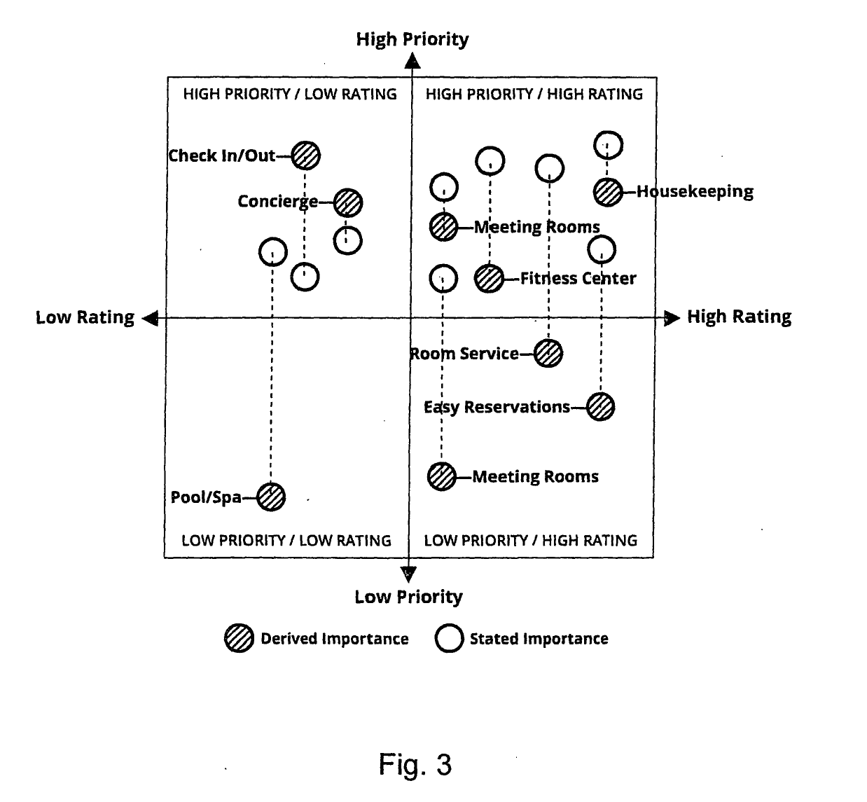

As noted above, the matrix of FIG. 2 takes into consideration non-explicit information, such as procedural, behavioral information, as well as explicit information, which is the survey answer, itself. FIG. 3 is an example of a matrix comparing explicit responses, as in FIG. 1, to the use of non-explicit information along with explicit information. In FIG. 3, summaries of the responses for the same services in FIG. 2 based on stated, explicit ratings and importance, are shown in open circles or icons in FIG. 3, while summaries of responses of FIG. 2, in which importance is derived from non-explicit information, are shown in cross-hatched icons. In this example, the differences in importance between explicit responses and non-explicit, behavioral information are shown. In certain cases, the differences are so great that the icons fall into different quadrants. For example, the stated importance of the Pool/Spa, based only on explicit information, is in the quadrant for High Priority/Low Rating, while the derived importance based non-explicit information places Pool/Spa in the Low Priority/Low Rating. Sometimes the differences are small and do not move a service out of a quadrant, such as with Housekeeping, Meeting Rooms, and the Fitness Center. FIG. 3 shows the advantages of deriving importance based on non-explicit information, as well as the advantages of displaying the survey results in a two-dimensional grid, such as a matrix, in accordance with embodiments of the invention. In this example, the consideration of non-explicit information did not change the explicit ratings. However, it is possible that explicit ratings may also change due to non-explicit information. For example, if consideration of non-explicit information indicates that an answer is faked or not reliable due to being made too fast of too slow, then that answer may be removed from the set from which the explicit ratings will be derived. This may result in a change in the resulting average rating, for example.

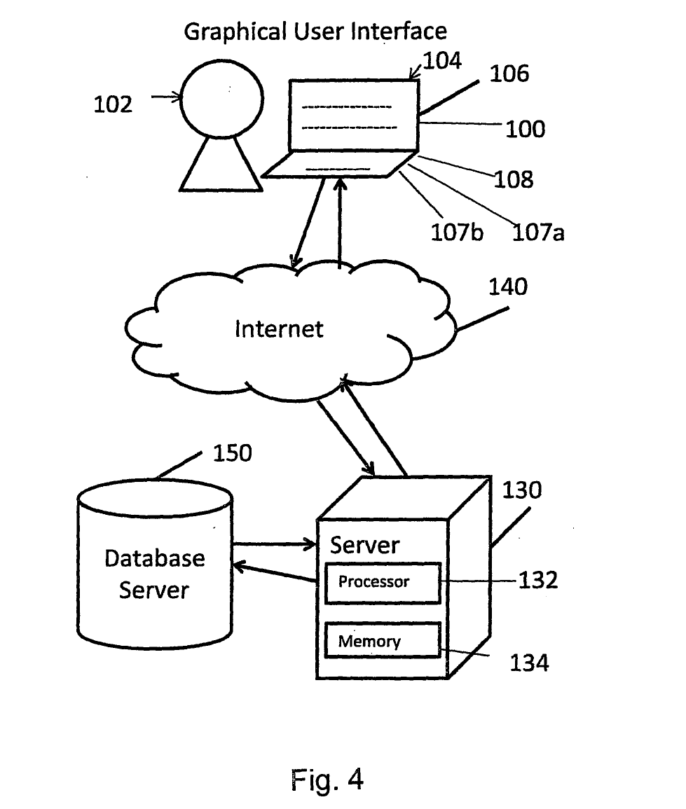

FIG. 4 is a block diagram of an example of a system for implementing surveys allowing for the collection of non-explicit information along with explicit information, and displaying the survey results in a two-dimensional grid on a respondent's display device, in accordance with embodiments of the invention. The system is described in more detail in the '514 Publication, which is incorporated by reference herein in its entirety and further identified above. A respondent 102 is shown next to a computing device 104 having a display 106 and an input device 107, such as a mouse 107a or a keyboard 107b. The respondent 102 takes a survey 108, which is displayed on the display 106 in the form of a graphical user interface (“GUI”) 100. The GUI 100 and the survey 108 are provided to the respondent's computing device 104 by a web server 130 via a network 140, such as the Internet, for example. A database server 150 or other storage device is coupled to or is a part of the server 130. The server 130 includes a processor 132, such as a computer, microcontroller, or microprocessor, for example, and memory 134. The term “server” is broadly defined and means either a processing device, such as physical computer, or a virtual server defined by a processor, such as a physical computer.

To construct, populate, render, present, or display the GUI 100 on the display 106 of the computing device 104, the server 130, under the control of a software application stored in the memory 134, pulls information from the database server 150. The web server 130 provides the information, including JavaScript visualization code and HTML code, to the computing device 104 via the network 140. In this example, the computing device 104 then constructs the GUI 100 within a browser based on the information, in a manner known in the art.

The respondent's computing device 104 may be a desktop computer, a laptop, a tablet, a smartphone, or any other computing device with a display 104, which can be coupled to the network 140. If the computing device 104 has a touchscreen, it may also be used as an input device 107. The computing device 104 includes a processor (not shown), such as a microprocessor or microcontroller, and memory (not shown), as is known in the art.

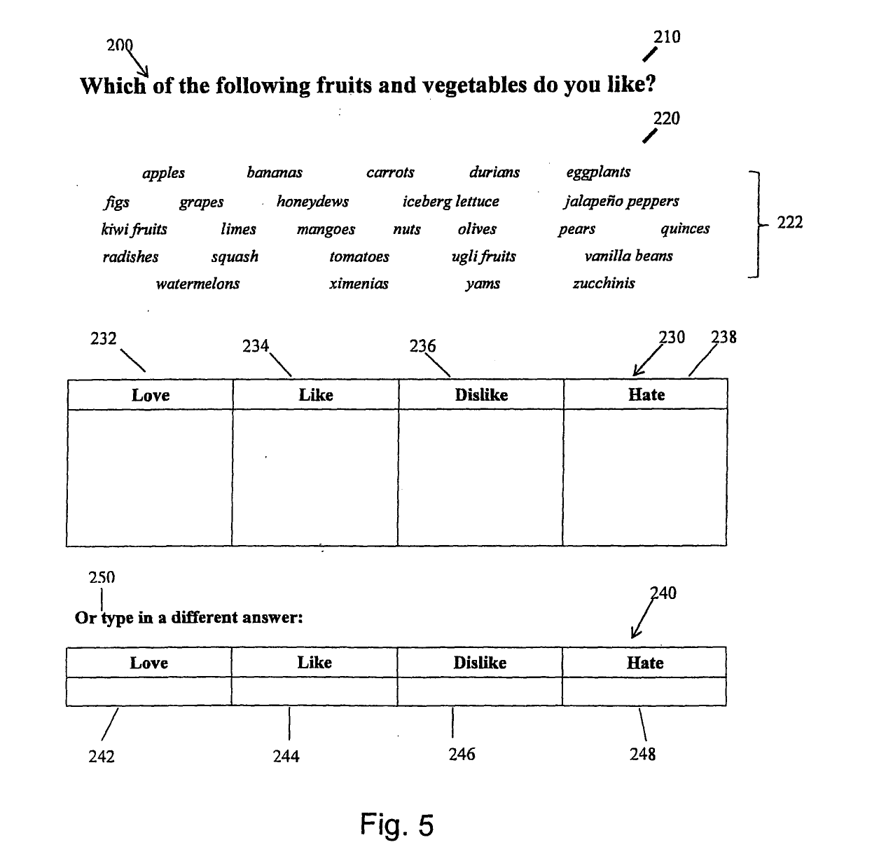

FIG. 5 is an example of a GUI 100 that may be displayed by a web browser on the display 106 of the computing device 104 to enable a respondent 102 to take a survey 108, in accordance with an embodiment of the invention of the '514 Publication. Other survey formats and GUIs allowing for the capture of non-explicit information along with explicit information may be used.

In this example, the GUI 200 provides a narrative space 210, an overview space 220, a response space 230, and an optional input space 240. The narrative space 210 can be short and simple, long and descriptive, or a combination of both. The narrative space 240 provides the instructions or describes the story, question, narrative and/or topic of the survey. It is usually provided by the GUI 200 at a top of each survey set or survey page, but that is not required. The narrative space 210 may also be presented in a separate page or window before the respondent proceeds to respond to the survey. In this example, the narrative space 210 in FIG. 5 includes the question, which in this example is: “Which of the following fruits and vegetables do you like?”

The overview space 220, which in this example is below the narrative space 210, contains response objects 222 corresponding to that particular topic. In general, the response objects 222 may be words, phrases, sentences, images, or any type of GUI object that a respondent can select with an input device 107. In this embodiment, the response objects 222 are words, such as apples and bananas, and groups of words, such as iceberg lettuce and jalapeno peppers, for example. In another example, the response objects 222 may be images of the fruits and vegetables. Also in this example, the response objects 222 in the overview space 220 are arranged in alphabetical order (from A through Z), but the response objects need not be arranged in any particular order. The only requirement is that each response object is a discrete object so that a user can identify and select it.

A response space 230 is provided for placement of respective response objects 222. In this embodiment, the response space 230 is divided into four containers 232, 234, 236, 238 corresponding to predetermined responses and indicating how the respondent may respond to the question: “Which of the following fruits and vegetables do you like?” or other questions.

Each of these containers 232-238 has a specific rating, as in a Likert scale. Here, the Likert ratings or scales are “love,” “like,” “dislike,” and “hate.” Other scales may be used and/or the response space may be grouped in distinct circles or other distinctive shapes for creating response containers. In this example, the respondent 102 may select respective response objects 222 in the overview space 220 and then drag and drop each response object into the appropriate container 232-238, depending on whether the respondent loves, likes, dislikes, or hates a particular fruit or vegetable.

This example does not provide a response of “neutral” because it is assumed that if the user does not have an opinion about a particular fruit or vegetable, the user will simply decide not to respond. A non-response may be interpreted as not eliciting a strong enough opinion for the respondent 102 to place the response object 222 in a love, like, dislike, or hate response box 232-238 respectively. A neutral option may also be provided.

An input space 240 may also be provided for the respondent to enter unique responses not listed among the response objects 222 in the overview space 220, as shown in FIG. 5. In this embodiment of the '514 Publication, the input space 240 is divided into four text fields 242, 244, 246, 248 that correspond to the four containers 232-238 in the response space 230. An instruction field 250, for example, is also provided to, in this example, inform the respondent 102 to “type in a different answer.” In other embodiments, the input space can be any type of input field, including but not limited to text boxes, comment boxes, buttons to upload pictures, buttons to record sounds, or buttons to open up new input field, box, window, or page. The respondent can add a unique response that is not provided in the overview space by typing, inputting, or uploading a new response object. In this embodiment, the respondent's additional response object may be a word or a phrase. In some embodiments, there is no input space 240 because the survey creator did not want to provide such an option.

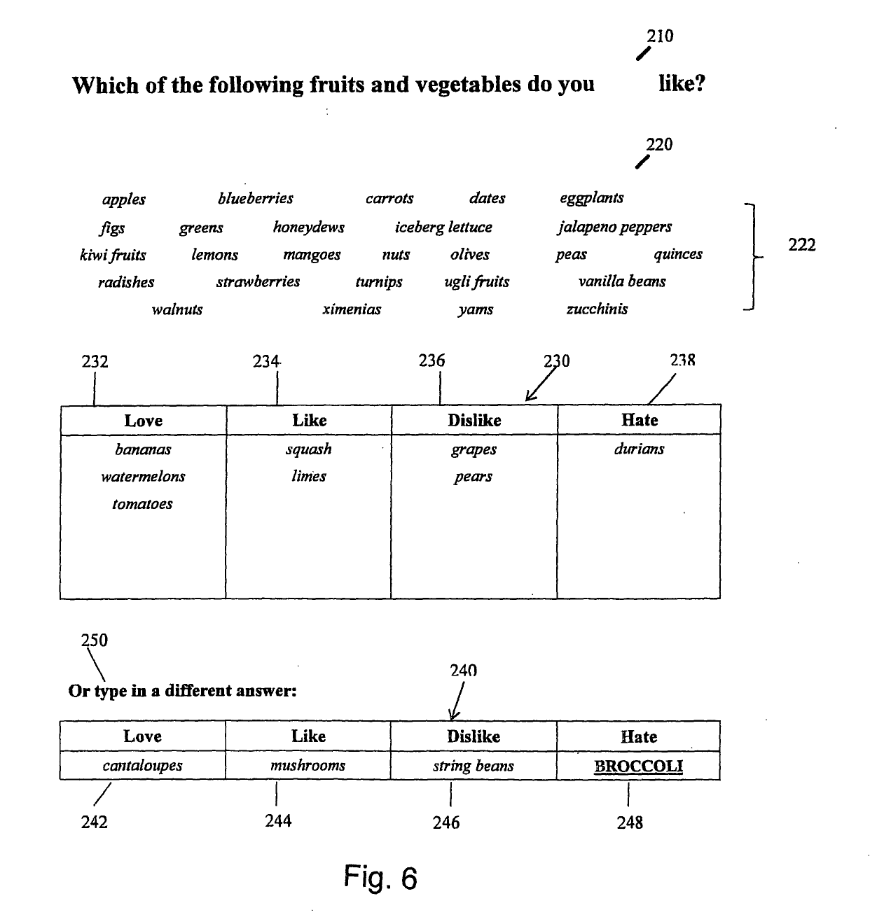

FIG. 6 is an example of the GUI 200 after being at least partially completed by a user 102. As shown in FIG. 6, the user selected the Bananas, Watermelons, and Tomatoes response objects 222 from the overview space 220, and dragged and dropped the selected response items in the response space 230 under the “Love” container 232. The user selected the Squash and Limes response objects 222 from the overview space 220, and dragged and dropped them in the response space 230 under the “Like” container 234. The user 102 selected the Grapes and Pears response objects 230 from the overview space 230 and dragged and dropped them in the response space 230 under the “Dislike” container 236. The user 102 selected the Durian response object 222 from the overview space 220 and dragged and dropped it in the response space 230 under the “Hate” container 238. Additional information is provided in the '514 Publication.

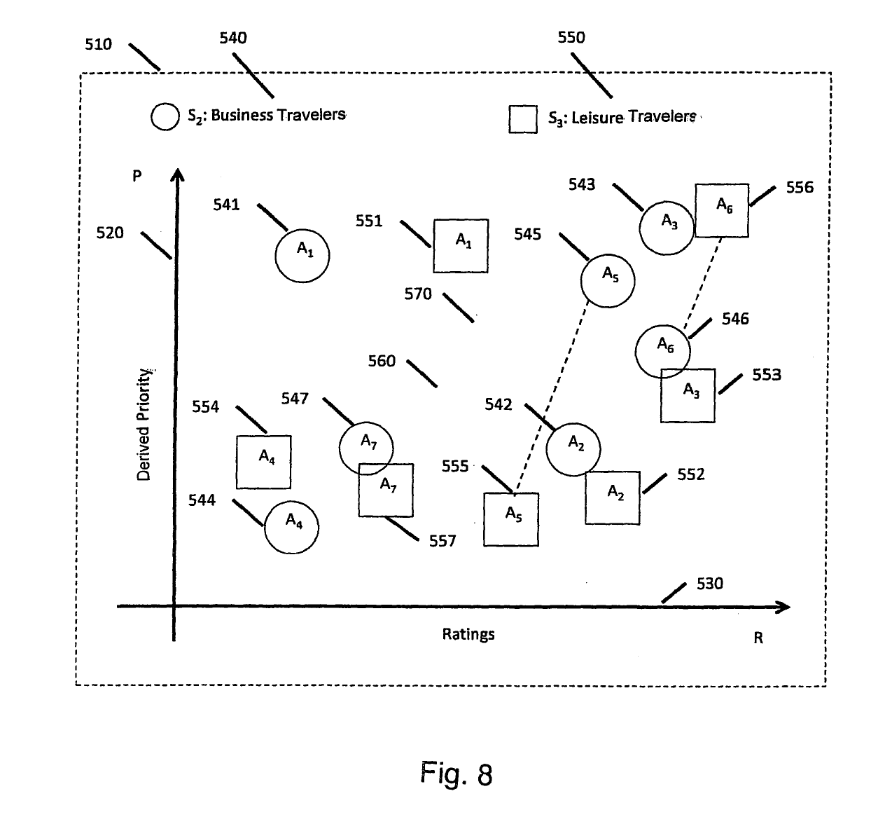

In one example, processing and analysis of survey results are performed in accordance with the techniques described with respect to FIG. 8 of the '514 Publication. Ratings may be statistically summarized, such as by averaging from the selected ratings from all or a subgroup of respondents. The average of the ratings may comprise a mean or median, for example. Non-explicit information may be derived from the recorded behavior of the respondent while placing objects in respective rating containers in response to survey questions by statistical analysis, such as by object-order of choice relationship analysis, object-topic relationship analysis, object, object-rating scale relationship analysis, and/or object-latency relationship analysis, for example, as described in the '514 Publication. It is noted that in the '514 Publication, “word” is used instead of “object” in these relationships. Other statistical analysis techniques may be used along with or instead of those described in the '514 Publication.

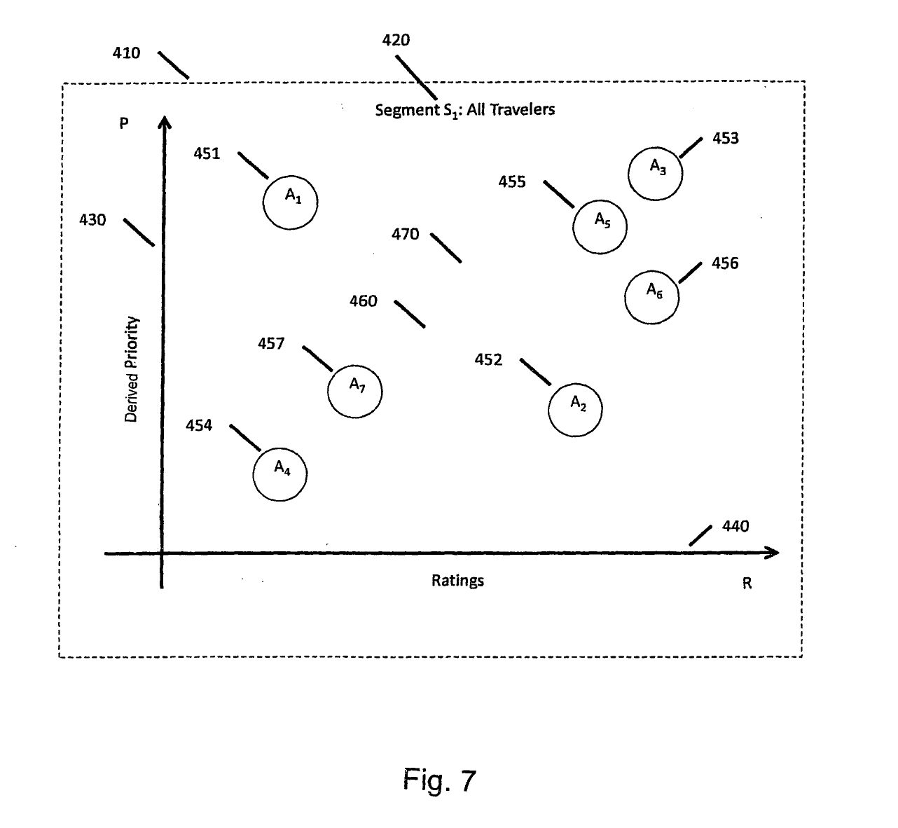

FIG. 7 is another example of the presentation of the results of the hotel customer satisfaction survey discussed above, to users, in a matrix, in accordance with an embodiment of the invention. In this example, the survey results from all the travelers taking the survey are displayed. The matrix is therefore headed “Segment S1: All Travelers.” In other examples discussed below, the segments displayed are for subgroups of All Travelers, such as business travelers and leisure travelers.

In this embodiment of the invention, two lines 460, 470 are used to show a visual partition of the two-dimensional space to form quadrants of a matrix. The line 460 separates high priorities (above) from low priorities (below). The line 470 separates low ratings (left) from high ratings (right). This helps analysts to clearly see the four quadrants in this space: high priorities and high ratings, high priorities and low ratings, low priorities and high ratings, and low priorities and low ratings, in this example. The vertical axis 430 is the priority dimension (the predicted priority for each answer), and the horizontal axis 440 is the ratings dimension (the overall rating for each answer). The answers are plotted in the two-dimensional space using each answer's priority and rating as the coordinates. The ratings for respective objects A1-A7 (A1: Check In/Out; A2: Easy Reservation; A3: Housekeeping; A4: Pool/Spa; A5: Fitness Center; A6: Room Service; A7: Concierge, for example), are shown in circles 451-457, for example.

The location of the circle or other representation of an object in FIG. 7 and other matrices described herein may be based on a combination of the explicit and non-explicit responses related to a respective object. For example, ratings may be statistically summarized by averaging from the selected responses, and a statistical analysis of non-explicit information may also be performed, to determine where the circle representing a respective object is to be placed with respect to the derived priority vs ratings axes. The average may be a median or mean, for example.

As mentioned above, survey administrators may group the survey responders into subgroups (or segments). The results of the subgroups may be displayed on separate two-dimensional grids or the same two-dimensional grid, to study and compare the responses to the same survey questions by the selected segments. Segments may be based on demographic information collected from the respondent in response to survey questions. Demographic information includes age, gender, zip code, geographic region, salary, and/or education, for example. Segments may also be based on non-demographic characteristics of the respondent, such as whether the respondent is a business traveler or a leisure traveler, first time guest or returning guest, honors guest or non-honors guest, etc. Segments may also be based on opinions of a respondent, such as respondents who found the hotel to be satisfactory or unsatisfactory, happy or unhappy customers, etc. Characteristics of respondents for the purpose of creating segments, for example, may be determined based on appropriate survey questions, such as demographic questions, for example. Demographic information may also be determined by combining survey data with other database data (such as CRM and employee databases), for example.

Non-demographic characteristics of respondents may be identified through other survey questions, through a multiple-choice question in the survey. For example, a question such as “Are you traveling for business or leisure? (a) Business, (b) Leisure, (c) Both” may be used to determine whether the respondent is a business or leisure traveler. Another example of a non-demographic question related to the status of respondents is: “Are you a first time guest,” etc.

Further subgroups may be defined based on the collected information such as business travelers who are male, business travelers who are female; leisure travelers who are 20-30 year olds; leisure travelers who are 31-40 year olds. Additional layers of subgroups, such as business travelers who are female and 31-40 years old, may similarly be studied. In one example a subgroup may be a segment (“females,” for example), and in another example the same subgroup may be the subgroup under a segment (“business travelers” who are “female,” where the segment is “business travelers” and the subgroup is “females,” for example). The use and creation of segments are driven solely by the analysis needs. There is no limit of how many segments can be created and displayed. Desired data for subgroups may be retrieved from the database server 150 and used to generate the desired two-dimensional grids, as discussed further below.

FIG. 8 is an example of how the priority matrix view may be used to compare the results of the same question from two different subgroups or segments of survey responders in accordance with an embodiment of the invention. In FIG. 8, derived priorities and ratings for Segment S2: Business Travelers 540 and Segment S2: Leisure Travelers 550 are both displayed at the top of the matrix 510. The matrix 510 in FIG. 8 has the same structure as in FIG. 7, with priority information on the vertical axis 520, the ratings information on the horizontal axis 530. Two lines 560, 530 in FIG. 8 partition the two-dimensional space into the same four quadrants of FIG. 7.

As indicated next to the segment names S1, S2 answers from Business Travelers are represented as circles A₁ through A₇ labeled as 541 through 547, respectively, and answers for Leisure Travelers are represented as squares A₁ through A₇ labeled as 551 through 557, respectively. Comparisons may be highlighted using lines that connect corresponding answers, such as the line connecting A₅ for business vs. leisure travelers or the line connecting A6 for business vs. leisure travelers, for example.

The size of each circle/square may be varied to represent the relative number of respondents selecting a respective object, or to represent the relative number of users providing the same combination of object and rating, for example. The size, shape, color, font, shading, opaqueness, highlighting, etc., used to display an answer may also be varied to express or identify a segment, attribute, or other characteristic of the respondents. In this example, the portion of respondents that have expressed an opinion about the same answer may be considered non-explicit information.

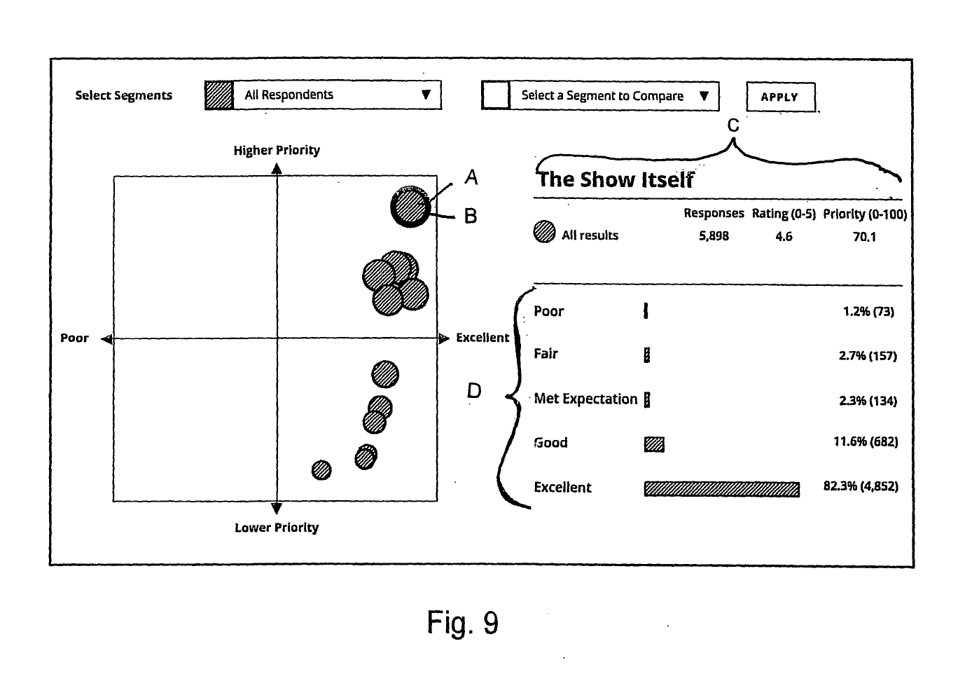

FIG. 9 is an example of a display of results from an actual patron satisfaction survey of a non-profit theatre, in accordance with an embodiment of the invention. In this example, respondents were asked to rate aspects of their experience at a theater, including rating “The Show Itself.” Results from all respondents are summarized and displayed. The Poor to Excellent scale ratings are shown along the horizontal axis. The priority ratings (from Lower Priority to Higher Priority) are shown along the vertical axis. The results are computed from explicit responses and a variety of useful summary statistics of non-explicit information based on survey respondents' behavior, as described in the '514 Publication.

In this example, when a user moves a mouse-over a circle, such as circle A, a darkened border B is provided around the circle to highlight the selected answer. The name of the selected object (“The Show Itself”) appears in a pop-up C, to the right of the matrix in this example, along with additional information. For example, the pop-up includes the number of respondents who provided their opinions about “The Show Itself,” here 5,898, with an overall priority of 70.1 (a score computed using methods described in the '514 Publication, Section 4.4, for example), and a mean rating of 4.6 (using a 5-point scale to represent the Likert scales Poor, Fair, Met Expectations, Good, and Excellent). The exact numbers of respondents that paired “The Show Itself” with each of the Likert scale are also displayed as bar charts in section D of the pop-up. Compared with everything else, “The Show Itself” is of the highest priority to the overall patrons of the theatre as a whole, as indicated by circle A in the matrix. These highlighting and pop-up features may be implemented by Java Script visualization code and HTML code, for example, in a manner known in the art. In this and other figures in order to provide room for the pop-up C, when the pop-up is selected, the size of the matrix may be reduced.

“Attributes” may also be used to identify other characteristics of the survey set. In this example, an attribute of “the number of responders that have expressed an opinion about each answer” is used to control the sizes of the circle representing each answer to the question related to “The Show Itself”. Attributes are discussed further below.

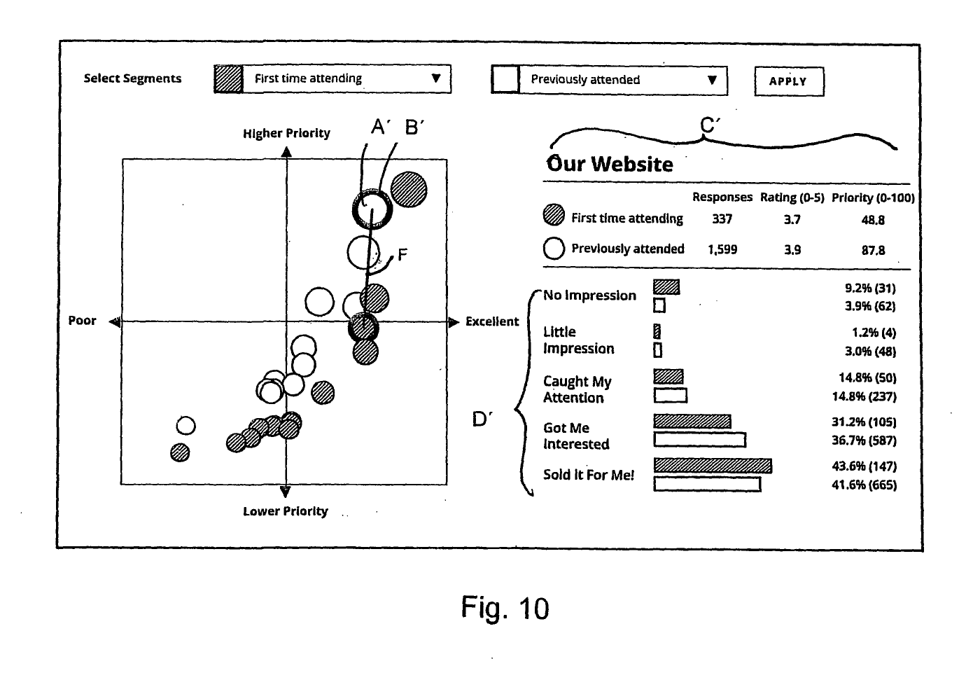

FIG. 10 is another example of a display of survey results from the same survey as in FIG. 9. FIG. 10 compares overall marketing effectiveness across a first segment of first time customers (“first time attending”) versus as second segment of repeat customers (“previously attended”). The segment information can be obtained by asking a question such as “How many times have you come to shows at [the theatre] in the past? (a) My first time, (b) Once a year or fewer, (c) A few times a year, (d) About once per month, (e) More than once per month.” In one example, if a respondent answers too quickly, such as in less than 0.5 or 0.2 seconds, for example, the answer may be excluded from consideration as non-explicit information indicating a lack of sufficient consideration of the question.

Answers from the first time customers are shown in shaded circular icons, while answers from the repeat customers are shown in clear circular icons. Different shadings or different colors may be used instead. As a user highlights the circle A′ for “Our Website” by a mouse-over or a clicking event, an “Our Website” pop-up C′ appears to the right of the matrix, and a line E is used to connect the two occurrences of “Our Website” on the chart. The pop-up provides detailed information for these two segments, including how many respondents chose the answer “Our Website” and placed the answer in a Likert scale box. The detailed breakdown per each Likert scale is also shown as bar charts D′ in the pop-up. It is apparent that the group salience and priority of the theatre's website (“Our Website”) is much higher among repeat customers than among first timers, although the two crowds gave very comparable stated ratings to “Our Website”.

The detailed view D′ in this example shows a breakdown per each Likert scale as bar charts. It is clear that the group salience and the priority of the theatre's website (“Our Website”) are much higher among repeat customers than among first timers, although the two groups of responders (i.e. customer segments) gave very comparable explicit (i.e. stated) ratings to “Our Website”.

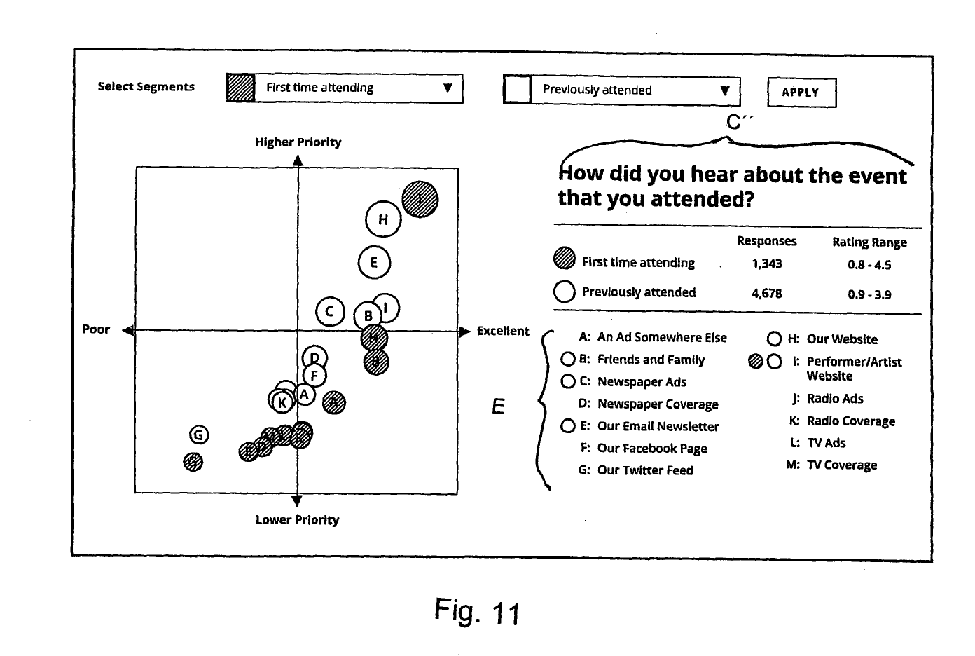

There are many ways to extend the analytical results in FIGS. 9 and 10. In FIG. 11, where the question is “How did you hear about the event that you just attended?”, the right side pop-up C″ includes a list view E. In FIG. 11, results are displayed for two segments First Time Attending and Previously Attending. The survey options for responding to the question are ordered and labeled alphabetically. The alphabetic labels are also shown inside each circle in the priority matrix on the left. Beside each item in the right-hand side list view E, a highlighting-dot is used to indicate options B, C, E, H, and I, which have high priority (defined as appearing above the x-axis in the priority matrix of FIG. 11). The highlighting-dots are shaded in the same way as the corresponding circles in the priority matrix. The view E is a concise summary of how the set of high priority items vary across two segments. In this case, “Performer/Artist Website” is the only highlighted item for the “First time attending” segment, whereas five (5) items are highlighted for the “Previously attended” segment. Those five (5) items are: Friends and Family, Newspaper Ads, Our Email Newsletter, Our Website, Performer/Artist Website.

Right above the right-hand side list view, some summary statistics are displayed. In this case, the “First time attending” segment includes 1,343 responses, with explicit ratings given for all items ranging between 0.8-4.5. The “Previously attended” segment includes 4,678 responses, with explicit ratings given for all items ranging between 0.9-3.9.

The selection criteria of which items to highlight in the list view can be flexibly set and changed according to the interests of the user.

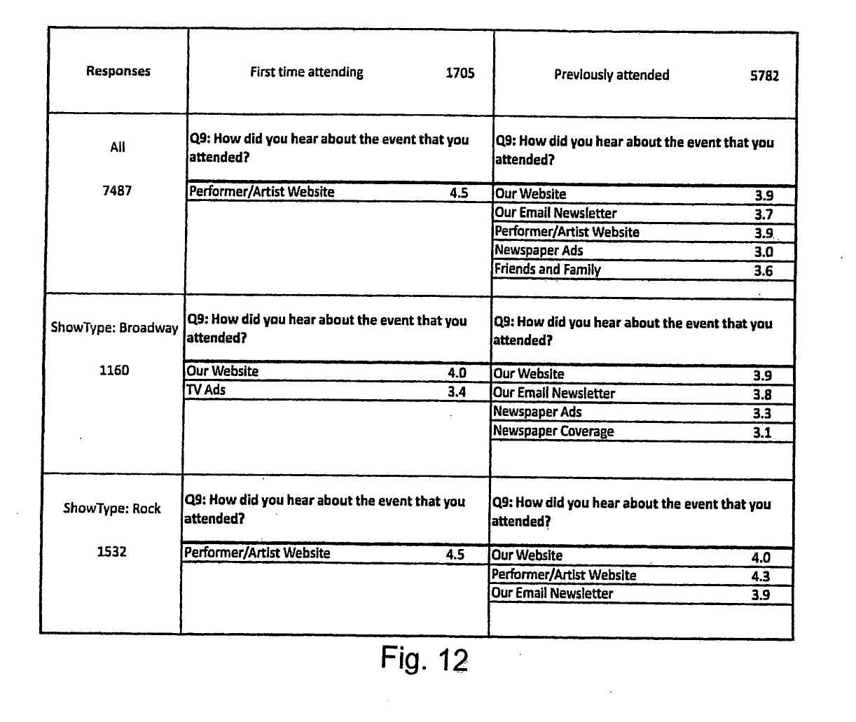

In FIG. 12, the list view is a tabular view, where the columns attain the semantic meaning of “customer profiles” or “employee profiles” or “donor profiles”. In this example, the profiles are for two segments, “new” customers and “repeat” customers. The rows correspond to secondary segments constructed as subgroups within each profile. For example, the first row “All” is a most general subgroup. The second row limits the subgroup to all customers for “Broadway” shows, and the third row limits the subgroups to all customers for “Rock” shows.

Within each cell (per subgroup under each profile), the highlighted items correspond to the highlighted items in the list view of FIG. 11. If there are multiple highlighted items, they are ordered by the priority (from high to low). The explicit ratings reported in FIG. 11 are also shown beside each item in the tabular view. For example, for “All” respondents in the first row. “Performer/Artist Website” is the only highlighted item for “First time attending” and its impression score is 4.5 on a 5-point scale. In contrast, for “Previously attend”, a list of five (5) items are highlighted: “Our Website,” “Our Email Newsletter,” “Performer/Artist Newspaper Ads,” and “Friends and Family.” The individual impression scores are displayed on the right as 3.9, 3.7, 3.9, 3.0, and 3.6 respectively.

This tabular form is appropriate for summarizing multiple subgroup in the same overview. For example, you can easily see that for “First time attending” customers of the “Broadway” shows, the highlighted items are “Our Website” and “TV Ads.” For “Previously attended” customers of the “Broadway” shows, “Our Website” remains a highlighted item, but all other highlighted items are different: “Our Email Newsletter,” “Newspaper Ads,” and “Newspaper Coverage.” This clearly summarizes that “TV ads” and “Newspaper” are two mediums that have attracted different customer profiles. One can easily investigate the same kind of differentiation for “Rock” shows using corresponding rows below those for “Broadway.” There is no limit on how many customer profiles can be included in the tabular view, nor on how many subtypes can be included.

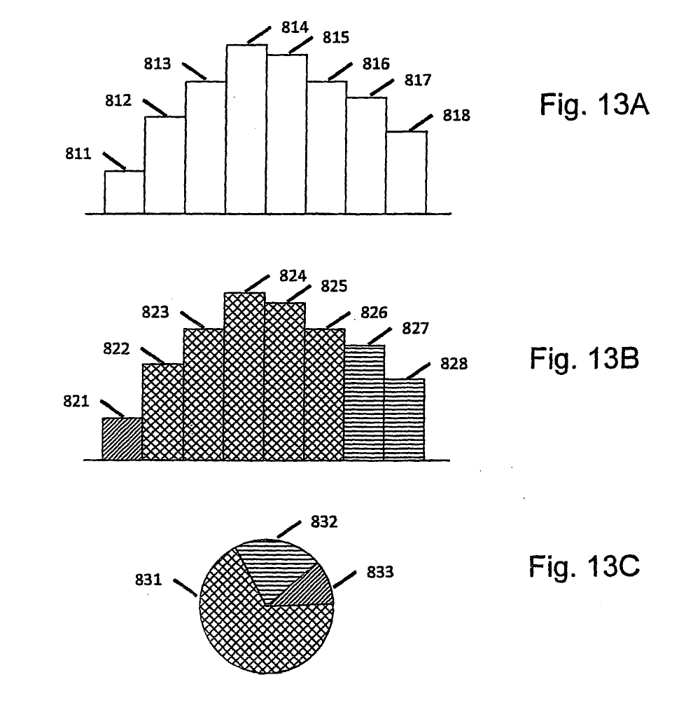

FIGS. 13A, 13B, and 13C show additional examples of summary statistics of non-explicit information. In FIG. 13A, a bar chart including bars 811-818 show a histogram of the amount of time (i.e., latency) taken by responders to express their opinions about each answer (e.g. “The Show Itself”). The bars correspond to consecutive intervals of latency, which can be customized by the analysts. For example, an analyst can use 0 to 200 milliseconds, 201 milliseconds to 400 milliseconds, 401 milliseconds to 600 milliseconds, etc., as intervals. The bar heights correspond to the number of responders that incurred a latency that falls into the corresponding interval of latency (e.g. 0 to 200 milliseconds). The analysts may be able to control the number of intervals (i.e. number of bars) are used in the bar chart. The bar chart of FIG. 13A, and other such representations, may be used instead of circles or other shaped icons to represent answers in the priority matrix view and/or the detailed view, for a respective object. Survey analysts can then more easily see and investigate whether different types of latency distributions are specific to particular regions in space of derived priority versus ratings.

In another example, the bar chart of FIG. 13B may be used instead of or in addition to the bar chart of FIG. 13A to show which responses to be kept and which response to be dropped from analysis. For example, the bar 821 indicates the responses with the shortest latency, showing how many responses are likely speeding through the survey; the bars 827 and 828 correspond to the longest latency and show the number of responses that are likely results of hesitation. The responses in either or both of bars 821, 827, and/or 828 may therefore be excluded from analysis. The responses falling within the bars 822-826 may be considered to be good results that can be further analyzed to provide useful information. As above, the user may determine the latency periods for each bar and which bars to include or exclude from further analysis. FIG. 13B may be based on the bar chart of 13A.

In yet another example, the categorized bar charts in FIGS. 13A and/or 13B can be further condensed, in the form of a pie chart with segments 831-833. For example, bars 826, 827, and 828, which represent respondents who have taken too long to answer a question, may be combined to form segment 831 in FIG. 13C. Bar 821, which represents respondents that answered too quickly, may be represented by segment 833 in FIG. 13B. Respondents who took an acceptable amount of time, represented in bars 822-826 in FIG. 13B, may be combined into segment 832 in FIG. 13C. In addition, the size of the pie charts can be further controlled based on the number of respondents that expressed an opinion about each answer, thereby combining multiple kinds of non-explicit information into the same analysis. Finally, these augmented analytical results of non-explicit information can be used in priority matrix view as well as the detailed view.

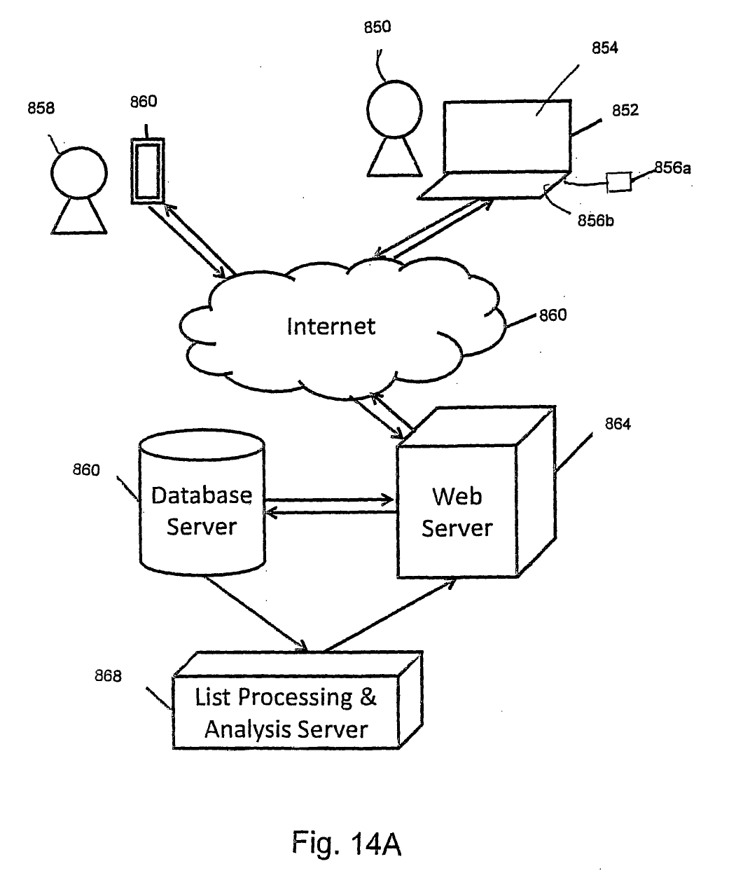

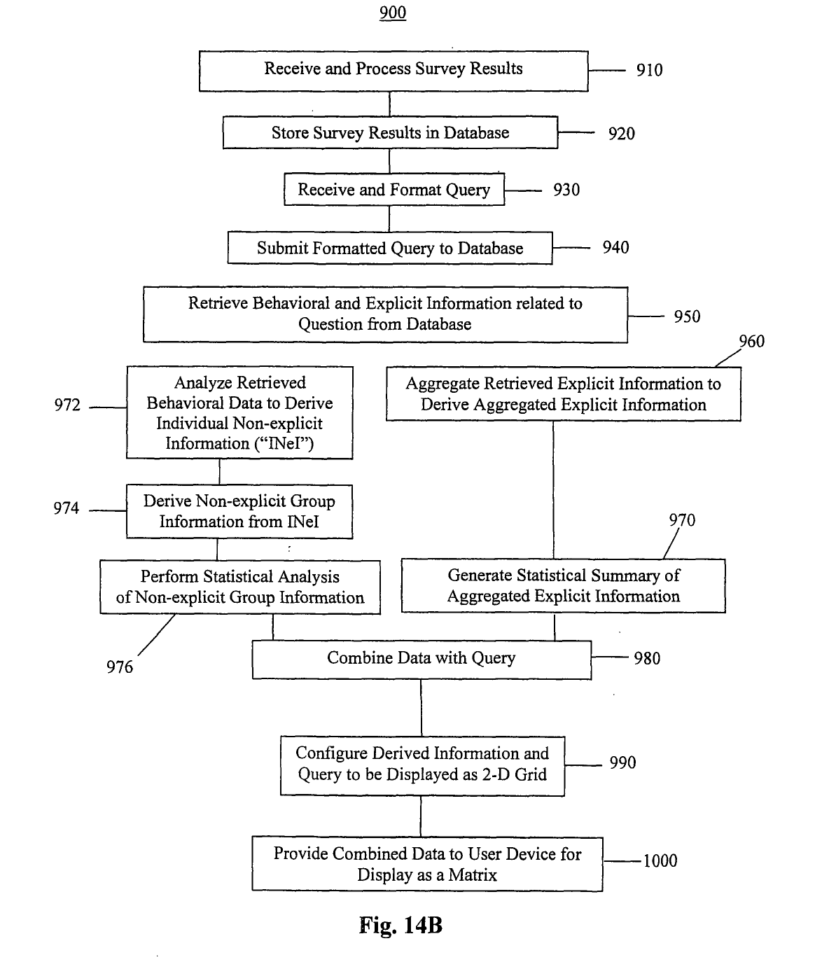

FIG. 14A is a block diagram of an example of a system for providing survey results including explicit and non-explicit information, such as ratings and derived importance or priority, respectively, to a survey analyst, in accordance with an embodiment of the invention. A survey analyst or user 850 is shown next to a first computing device 152 having a display 156 and an input device such as a mouse 856a and/or a keyboard 156b. The first computing device 152 may be a desktop computer, a laptop computer or tablet, for example. Another survey analyst or user 858 is shown next to a second computing device 160, which may be smartphone, for example. The system further includes the database server 150 of FIG. 4, a web server 864, which can be the same or a different web server than the web server 130 in FIG. 4, and a list processing and analysis server 868. The list processing and analysis server 868 may be part of the web server 864, may be part of the web server 964, such as a software module on the web server 964, or may be a separate processor web server including its own processor. In addition, the web server 864 may be the same as the web server 130 of FIG. 4 or a different server. The web server 864 also comprises a processor and memory (not shown). As above, the term “server” is broadly defined and means either a processing device, such as physical computer, or a virtual server defined by a processor, such as a physical computer.

FIG. 14B is flowchart of an example of a method 900 of processing survey data for display as a two-dimensional grid, by the system of FIG. 14A, for example, using a computing device 852, 860 of a respective survey analyst 850, 858, in accordance with an embodiment of the invention. In one example, the survey is presented on a GUI 200 on the display 106 of a respondent's computing device 100, as shown in FIG. 4 and discussed above. An example of a GUI 200 is shown in FIGS. 5 and 6, as discussed above, and described in more detail in the '514 Publication. The survey may be collected and/or processed to form “History Events,” for example, which are stored in the database server 150 in FIG. 4 and FIG. 14A, as also described in the '514 Publication. The survey data may be stored in other formats, instead.

Survey results, including explicit and non-explicit information, are received and processed in Step 910. The processed survey results are stored in the database server 150, in Step 920.

When a user 850, 858, for example, desires to see the survey results, such as the derived priority and rating information related to the survey question about customers' experiences in a hotel satisfaction survey, for example, the user formulates a query at the user's device 852, 860 and sends the query to the web server 864 via the Internet 140 or other such network. The query comprises a question, Qₖ, which corresponds with a survey question, and whether to limit the search results to one subgroup, referred to as a segment Sm, or a segment Sₘ. The query Qₖ may be limited by additional criteria, referred to as attributes “attr”. Attributes may include additional subgroups, for example, as discussed above. Attributes may also include other criteria, such as a date range for which survey results are desired, or respondents that provided high or low scores in an overall satisfaction question, for example. If no filtering parameters are specified, then in one example, query Qₖ is considered to be about a segment comprising all respondents of that survey.

The query is received and processed by the processor of the web server 864 (which here and in the following discussion may be processor 132 in FIG. 4 or a different processor), under the control of software stored in the memory in the web server 864 (which here and in the following discussion may be the memory 134 in FIG. 4 or a different memory), for example, in Step 930. Processing includes formatting the query into SQL queries for databases, or into data queries in other query languages for other big-data repositories, for submission to the database 150, for example.

The formatted query Qₖ is submitted to the database server 150, in Step 940. The database 150 filters the data in the stored History Events in the database 150 based on the query Qₖ, and the segment Sₘ and attributes att, if present. Data retrieval and filtering are described in the in the 514 Publication, for example.

Behavioral and explicit information related to the query is retrieved by the database server 150 and provided to the web server 864, in Step 950. The processor 132 of the web server 864 processes the behavioral information and the explicit information separately. The explicit information from individual History Events are aggregated by the processor 132 to derive aggregated explicit information, in Step 960. A statistical summary of the aggregated explicit information is generated by the processor in the web server 864, in Step 970.

The retrieved behavioral information is analyzed by the list processing and analysis server 868 (“server 868”) to derive individual non-explicit information (“INeI”), in Step 972. Non-explicit group information is derived from the INeI by the server 868, in Step 974. A statistical analysis of the non-explicit group information is performed by the server 868, in Step 976. The statistical analysis may be performed in accordance with the List Construction and Analysis Section 830 of FIG. 8 and associated description of the '514 Publication, for example.

The statistically analyzed non-explicit group information from Step 976 and the generated statistical summary of the aggregated explicit information from Step 970 are combined with each other and with the query Qₖ by the processor 132, in Step 980. Alternatively, the query Qₖ may be combined with the statistically analyzed non-explicit group information and the generated statistical summary of the aggregated explicit information by the browser of the user's computing device 850, 858, as discussed below.

The combined data/query is configured to be displayed in the form of a two-dimensional grid by a web browser on the user's computing device, by the web server 864, for example. The data/query may be configured by adding JavaScript visualization code and/or HTML code to the combined data/query for display as a two-dimensional grid, such as a matrix, for example. Other functionality of the two-dimensional grid discussed above may also be provided adding JavaScript visualization code and/or HTML code by the web server 864 in Step 990, for example.

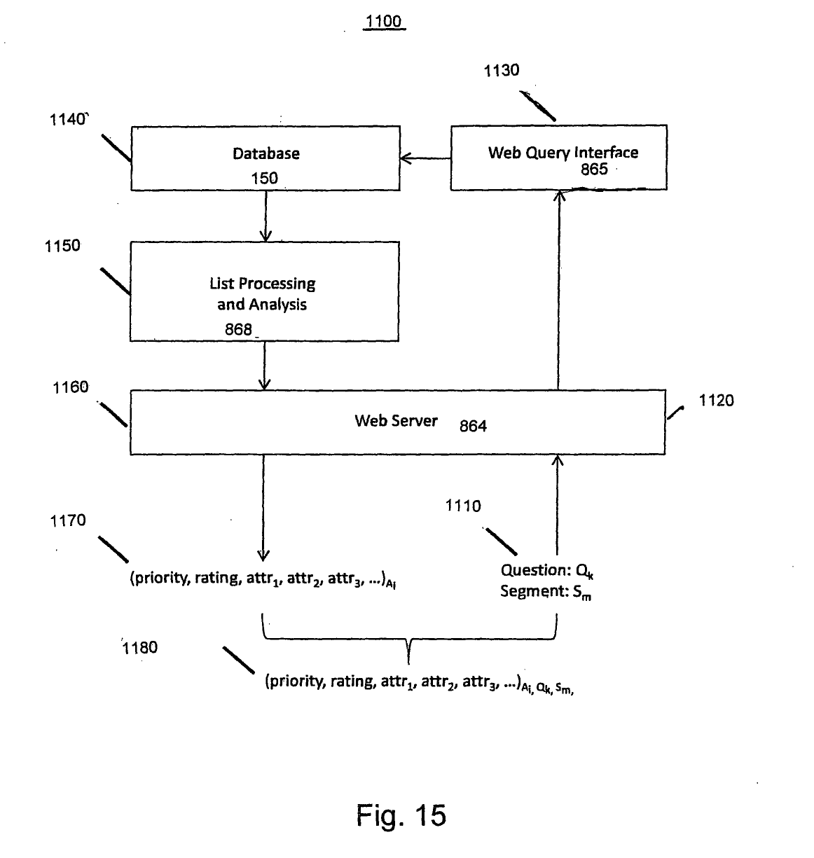

FIG. 15 is an example of a flow diagram 1100 of the process of FIG. 14B, with respect to the system FIG. 14A. The flow diagram 1100 starts with the creation of a query Qₖ, segments Sₘ, if any, and any further subgroups or attributes, attr₁, att₂, . . . , if any, by the user 850, 858, in Step 1110 of FIG. 15. The query Qₖ is submitted to the web server 864, via the Internet 860 or other such network, as discussed above. The query Qₖ is received by the web server 864 in Step 1120.

In this example, query Qₖ 350 is formatted for submission to the database server 150 so that the database server can retrieve the desired data by a web query interface 136, which may be software module in the memory of the web server 864 server 868 or may be a separate processor, for example. The web query interface formats the query Qₖ and submits the query Qₖ to the database server 150 (see Step 930 of FIG. 14).

Using methods described in the '514 Publication, a list of History Events are retrieved by the database server '514 and processed in the server 868, at Step 1150. The server 868 performs Steps 960-976 of FIG. 14, as described and may perform Steps 840, 850, and 860 of FIG. 8 of the '514 Publication, for example. The list processing performed in Step 950 of FIG. 8 of the '514 Publication may be used to compress or encrypt the list of tuples before the tuples are transmitted across the network to the display device of a survey administrator.

The result of the list processing and analysis by the server 868 contains a list of tuples 1170, one tuple per aggregated answer, Ai, to the question. The tuple list 1170 may be associated with JavaScript visualization code and HTML code by the web server 864, for example, to enable display as a two-dimensional grid, such as a two-by-two matrix, for example, by the browser of a user's computing device 852, 860. The computing device may be a desktop computer, laptop computer, tablet or smartphone, for example.

The tuple list 1170 and the information in the query Qₖ may be combined in one example to produce the end result 1180 for display on the display of the user's computing device. Hence, the list is augmented with the query information and segment information to yield:

(priority,rating,attr₁,attr₂,attr₃, . . . )_{A}_{ᵢ}_{,Q}_{ₖ}_{,S}_{ₘ}

As discussed above, the tuple list 1170 and the query Qₖ may be combined in the browser on the computing device of the user or in the web server 130, for example.

Returning to the example of FIG. 2, words or categories such as “Concierge” services, “Housekeeping,” “Meeting Rooms,” “Fitness Center,” “Room Service,” “Reservations,” Check In/Out,” and Pool/Spa are provided in the hotel satisfaction survey discussed above, are answers, Ai, to questions Qₖ. The Likert scales for rating purposes are referred to as opinion, scale, or rating boxes. Opinions are expressed by pairing an answer, such as Concierge, with an opinion box, such as Excellent.

Continuing this example, suppose an answer in the customer experience question of the hotel satisfaction survey is “Concierge” services. The following is an example tuple for “Concierge”:

(priority,rating,attr₁,attr₂,attr₃, . . . )

The “priority” field in the tuple is the overall priority or importance of “Concierge” services, as predicted by the statistical analysis methods in Steps 972-976 of FIG. 14 and described in Section 4.4.1, Method 1 of the '514 Publication, for example.

The “rating” field may be the median or mean (e.g. on a 5-point to 10-point scale, for example) computed based on how survey respondents placed “Concierge” into rating boxes such as “Poor”, “Fair”, “Neutral”, “Good” and “Excellent,” as described with respect to Steps 960-962 of FIG. 14, for example. Rating may also be a value obtained using other ways to statistically summarize a list of pairings chosen by survey responders.

In one example, ratings are determined by the most popular pairing. If “Concierge” and “Good” is the most popular pairing, then this pairing will be given an overall rating of Good. In another example, ratings are determined by the percentage of responders who have placed “Concierge” in either “Excellent” or “Good” rating box. This metric is sometimes referred to as “Top-2 box” score. The framework used to present priority—rating information in this embodiment of the invention can generally handle different definitions of priority, as described in the '514 Publication (Section 4.4.1, Method 1 and Section 4.4.2, Method 2, for example). It is noted that the terms word-order, word-topic, and word-scale relationship analysis described in the '514 Publication are referred to herein as object-topic, object-rating, and object-scale relationship analysis.

The tuple 1170 and 1180 also includes “attribute” fields. For each answer in the survey question, the list-processing and analysis module 868 in FIG. 15 can also produce an additional array of attributes (e.g. attr₁, attr₂, attr₃, . . . ) that can be included in the tuples 1170 and 1180. An attribute is an auxiliary metric that expresses characteristics of the collective opinions held by a segment of survey respondents regarding each individual response, such as object placement, or answers to a survey question. In accordance with an embodiment of the invention, a set of attributes of a tuple are calculated on a per answer basis for each survey question Qₖ. Each set of attributes are numeric characteristics of that answer, algorithmically computed based on survey responses from the group or segment of survey responders (segment Sₘ). The difference between segments and attributes is what is being studied at the time of the visualization. Segments are attributes selected for a specific comparison.

These attributes may be calculated from explicit as well as non-explicit information, as described in the '514 Publication. For example, attributes may be the number of responders who expressed an opinion about “Concierge” services by pairing the answer “Concierge” with any opinion box; the number of responders who spent a low amount of time (less than a predetermined threshold, for example) before pairing “Concierge” with an opinion box; the number of responders who changed their pairing decisions about the answer “Concierge”; the number of responders who changed from any one to (or a particular one) to any other (or to a particular) rating box to another, after a predetermined period of time; and/or the number or percentage of responders who hesitated about pairing “Concierge” with an opinion box by spending a long period of time (longer than a predetermined threshold, for example) before making the selection. Other explicit and non-explicit information about the respondent's answers may also be included as attributes.

If it is desired to focus on business and leisure travelers, for example, as in FIG. 4 discussed above, then the purpose of travel (which is in general an attribute), is considered a segment. Then, using the lens of business segment and leisure segment, other attributes, such as the opinions of respondents of particular genders, ages, or incomes, for example, may be determined and compared.

The tuple list 140 is specific to a respective query including a respective segment Sₘ and query Qₖ. In other words, as the query varies, the values in the per-answer tuple list will vary accordingly.

Examples of implementations of the invention are described above. Modifications may be made to these examples without departing from the spirit and scope of the invention, which is defined in the claims, below.

We claim:

1. A method for preparing survey data for display comprising:
retrieving, from a database, respective responses to at least one survey question in a survey taken by a plurality of respondents and behavior data recorded during taking of the survey by the plurality of respondents, in response to a query comprising the at least one survey question;
wherein:
the retrieved data comprises respective pairings of objects and ratings related to a respective survey question;
each pairing is stored in a respective record in the database and at least certain of the records further comprise behavioral measures of the behavior of a respective respondent with respect to pairing a respective object with a rating; and
the ratings comprise explicit information;
the method further comprising:
analyzing the retrieved behavioral data to derive individual non-explicit information for the respective respondents;
deriving non-explicit group information from the individual non-explicit information by performing a statistical analysis of the behavior measures in the records of respective respondents to derive priority for a respective object;
aggregating the retrieved responses to derive explicit ratings information by generating a statistical summary of the explicit ratings;
configuring the derived explicit ratings information and the derived group priority information for a respective object to be displayed in the form of a two-dimensional grid;
sending the configured information to a user's browser, via a network; and
displaying the configured listings on a user's display device in the form of the two-dimensional grid, by the user's browser.

2. The method of claim 1, wherein objects comprise words, phrases, and/or images.

3. The method of claim 1, wherein the statistical summary comprises an average.

4. The method of claim 1, wherein the statistical analysis comprises one or more of the following:
object-order of choice relationship analysis, object-topic relationship analysis, object, object-rating scale, relationship analysis, and object-latency relationship analysis.

5. The method of claim 1, further comprising:
deleting a respective response from the aggregated retrieved responses based on the derived non-explicit information.

6. The method of claim 1, further comprising:
forming a list of pairings of a derived priority and a statistical summary of the explicit ratings, for a respective object;
configuring the listing to be displayed in the form of the two-dimensional grid;
sending the configured listing to a user's browser, via a network; and
displaying the configured listings on the user's display device on the same two-dimensional grid, by the user's browser.

7. The method of claim 1, wherein the non-explicit information comprises:
a number of respondents responding to a question; a number of respondents who spent less than a first predetermined amount of time before responding to a question before responding to a question; and a number of respondents who spent more than a second predetermined amount of a number of responders who changed their response.

8. The method of claim 7, wherein:
determining whether the first and/or second predetermined time periods are exceeded based, at least in part, on time stamps associated with respective pairings.

9. The method of claim 6, wherein the query is limited to one or more subgroups of respondents, the method further comprising:
forming a separate listing for each subgroup, and/or forming a separate listing for each subgroup of a subgroup;
configuring each listing to be displayed on the same two-dimensional grid;
sending the configured listings to a user's browser, via a network; and
displaying the configured listings on the user's display device on the same two-dimensional grid by the user's browser.

10. The method of claim 9, comprising:
configuring the listing to cause display of one or more icons representative of the statistical summary of the explicit ratings and derived priorities for respective objects, on the two dimensional grid;
wherein the listings are further configured to enable one or more of the following:
varying the size of a respective icon based on a number of respondents that have selected the respective object in the survey;
varying a color and/or opacity of a respective icon based on a number of respondents that have changed their selection on a rating scale;
connecting corresponding icons for respective subgroups;
causing display of additional information in response to placement of a mouse over an icon;
causing highlighting of the icon in response to placement of a mouse over an icon cause's highlighting of the icon; and
causing display of information in the form of a tabular chart, bar chart, and/or pie chart.

11. A system for preparing survey data for display comprising:
a database;
a processor configured to:
retrieve, from the database, respective responses to at least one survey question in a survey taken by a plurality of respondents and behavior data recorded during taking of the survey by the plurality of respondents, in response to a query comprising the at least one survey question;
wherein:
the retrieved data comprises respective pairings of objects and ratings related to a respective survey question;
each pairing is stored in a respective record in the database, and at least certain of the records further comprise behavioral measures of the behavior of a respective respondent with respect to pairing a respective object with a rating; and
the ratings comprise explicit information;
the processor being further configured to:
analyze the retrieved behavior data to derive individual non-explicit information for the respective respondents;
aggregate the retrieved responses to derive explicit ratings information by generating a statistical summary of the explicit ratings;
derive non-explicit group information from the individual non-explicit information by performing a statistical analysis of the behavior measures in the records of respective respondents to derive priority of a respective object;
configure the derived explicit ratings information and the derived priority information for the respective object to be displayed in the form of a two-dimensional grid;
send the configured listing to a user's browser, via a network; and
cause display the configured information on a user's display device in the form of the two-dimensional grid, by the user's browser.

12. The system of claim 11, wherein objects comprise words, phrases, and/or images.

13. The system of claim 11, wherein the statistical summary comprises an average.

14. The system of claim 11, wherein the statistical analysis comprises one or more of the following:
object-order of choice relationship analysis, object-topic relationship analysis, object, object-rating scale, relationship analysis, and object-latency relationship analysis.

15. The system of claim 14, wherein the processor is further configured to:
delete a respective response from the aggregated retrieved responses based on the derived non-explicit information.

16. The system of claim 11, wherein the processor is further configured to:
form a list of pairings of a derived priority and a statistical summary of the explicit ratings, for a respective object;
configure the listing to be displayed in the form of the two-dimensional grid;
send the configured listing to a user's browser, via a network; and
display the configured listings on the user's display device on the same two-dimensional grid, by the user's browser.

17. The system of claim 11, wherein the non-explicit information comprises:
a number of respondents responding to a question; a number of respondents who spent less than a first predetermined amount of time before responding to a question before responding to a question; and a number of respondents who spent more than a second predetermined amount of a number of responders who changed their response.

18. The system of claim 17, wherein the processor is configured to:
determine whether the first and/or second predetermined time periods are exceeded based, at least in part, on time stamps associated with respective pairings.

19. The system of claim 18, wherein the query is limited to one or more subgroups of respondents, the processor being further configured to:
form a separate listing for each subgroup, and/or forming a separate listing for each subgroup of a subgroup;
configure each listing to be displayed on the same two-dimensional grid;
send the configured listings to a user's browser, via a network; and
display the configured listings on the user's display device on the same two-dimensional grid by the user's browser.

20. The system of claim 11, wherein the processor is configured to:
configure the listing to cause display of one or more icons representative of the statistical summary of the explicit ratings and derived priorities for respective objects, on the two dimensional grid;
wherein the listings are further configured to enable one or more of the following:
vary the size of a respective icon based on a number of respondents that have selected the respective object in the survey;
vary a color and/or opacity of a respective icon based on a number of respondents that have changed their selection on a rating scale;
connect corresponding icons for respective subgroups;
cause display of additional information in response to placement of a mouse over an icon;
cause highlighting of the icon in response to placement of a mouse over an icon causes highlighting of the icon; and
display the configured listings on the user's display device on the same two-dimensional grid by the user's browser.

21. A system for displaying survey data comprising:
a display device; and
a processor coupled to the display device, the processor being configured to:
send a query prepared by a user to a web server via a network, the query comprising a survey question and one or more subgroups of respondents, wherein the survey question is from a survey that collected explicit information and non-explicit information based on a behavior of the respondents while answering the survey question;
receive explicit and non-explicit information responsive to the query from the web server, the explicit and non-explicit information being configured to be displayed in the form of a two-dimensional grid; and
cause display of the received explicit and non-explicit information on the display in the form of the two-dimensional grid.

22. The system of claim 21, wherein the processor is further configured to:
combine the explicit and non-explicit information with the query; and
cause display of the explicit and non-explicit information with the query on the two-dimensional grid.
